(19) United States
(12) Patent Application Publication
(10) Pub. No.: US 2024/0340930 A1
(43) Pub. Date: Oct. 10, 2024

(54) METHOD FOR AUTOMATICALLY TRANSMITTING A NETWORK CONFIGURATION FOR ONE OR MORE TEXTILE MACHINES

(71) Applicant: c/o Saurer Spinning Solutions GmbH & Co. KG, Übach-Palenberg (DE)

(72) Inventors: Bert Hurtz, Meerbusch (DE); Jürgen Hüls, Mönchengladbach (DE)

(73) Assignee: c/o Saurer Spinning Solutions GmbH & Co. KG, Übach-Palenberg (DE)

(21) Appl. No.: 18/625,494

(22) Filed: Apr. 3, 2024

(30) Foreign Application Priority Data
Apr. 6, 2023 (LU) 503867

(51) Int. Cl. H04W 72/30; H04L 67/12; H04W 48/10

(52) U.S. Cl. CPC H04W 72/30; H04L 67/12; H04W 48/10

(57) ABSTRACT

The invention relates to a method for automated transmission of a network configuration for one or more textile machines in a network, wherein data are transmitted between a configuration unit and the one or more textile machines via a communication network with the network, the method comprising the following steps which are executed by the configuration unit:
initiating detection of the one or more textile machines within the network via the communication network for transmitting the network configuration,
identifying the one or more textile machines within the network on the basis of a respective identifier of the one or more textile machines obtained by the initiated detection,
providing the network configuration for each detected and identified textile machine in the network,
transmitting each provided network configuration to the one or more identified textile machines in the network on the basis of the respective identifier.

The present invention relates to a method for automated transmission of a network configuration for one or more textile machines. Further, the invention relates to a system, an apparatus, a computer program and a textile machine for this purpose.

It is known from the prior art that, in textile factories such as spinning mills, textile machines are increasingly being connected to a so-called control system. This allows, for example, the production data and status messages of all textile machines to be visualized or otherwise processed further at a central location. Conversely, production specifications and parameters (e.g. recipes) can be managed at a central location and transmitted to the individual textile machines. In general, each textile machine has a dedicated master computer or control computer which on the one hand is connected to the textile machine components via a fieldbus and on the other hand has an interface with the control system, which is usually designed as a network interface. For this purpose, it is necessary for all involved components, i.e. control system and textile machines, to have a unique address or IP address. So that the control system can address each textile machine in a targeted manner or can correctly assign data coming from the textile machines, it must know the addresses of all connected textile machines.

However, a disadvantage of known solutions is that the address management of textile machines takes place manually, i.e. the address of each textile machine is entered manually into a list. Furthermore, it is disadvantageous that the address of a textile machine is also set manually on the machine itself. This setting is required when each new textile machine is put into operation, but also when replacing a textile machine master computer or when the client reorganizes their textile machines. The setting process itself is also dependent on the type of textile machine. The disadvantage is that manually setting and managing addresses can be very time-consuming and error-prone.

Therefore, it is an object of the present invention to at least partially eliminate the disadvantages described above. In particular, it is an object of the present invention to propose an improved solution for simplifying the setting and management of textile machines.

Objects of the invention are a method having the features of claim 1, a system having the features of claim 11, an apparatus having the features of claim 13, a computer program having the features of claim 14, and a textile machine having the features of claim 15. Further features and details of the invention are apparent from the respective subclaims, the description and the drawings. Features and details described in connection with the method according to the invention naturally also apply in connection with the system according to the invention, the apparatus according to the invention, the computer program according to the invention along with the textile machine according to the invention, and vice versa in each case, such that, with regard to the disclosure concerning the individual aspects of the invention, reference is or can always be made mutually.

The method can be executed as a computer-implemented method or can be only partially executed by a computer. The latter can mean that method steps that are executed by the at least one textile machine are also provided.

The object of the invention is in particular a method for automated transmission of a network configuration for one or more textile machines in a network, wherein data are transmitted between a configuration unit and the one or more textile machines via a communication network with the network, the method comprising the following steps which are executed by the configuration unit:
initiating detection of the one or more textile machines within the network via the communication network for transmitting the network configuration,
identifying the one or more textile machines within the network on the basis of a respective identifier of the one or more textile machines obtained by the initiated detection,
providing the network configuration for each detected and identified textile machine in the network,
transmitting each provided network configuration to the one or more identified textile machines in the network on the basis of the respective identifier.

This has the advantage that a simpler and faster setting or configuration of a textile machine can be executed automatically because the initiation of the method according to the invention is controlled by the configuration unit. This can advantageously be executed repeatedly with corresponding programming. Furthermore, this has the advantage that automatic detection and unique identification of all textile machines in a network, including those that are added at a later point in time, makes management of the textile machines significantly easier and more efficient. The method according to the invention also allows the available services within the system to be used efficiently for the detected and identified textile machines according to the transmitted network configuration.

Data transmission means, for example, transmitting a request or a response, and/or transmitting a respective network configuration, and/or transmitting a command from the configuration unit to the one or more textile machines.

A configuration unit is to be understood in particular as an apparatus for configuring one or more textile machines, for example an apparatus for data processing which is provided for configuring software and hardware components of a system and/or network. Configuring comprises, for example, an adaptation of programs and/or hardware components of the system and/or the network.

Advantageously, the one or more textile machines comprise at least one of the following: spinning machine, textile machine for fiber preparation, textile machine for spinning preparation, ring spinning machine, compact spinning machine, rotor spinning machine, air spinning machine, automation machine, winding machine, texturing machine. In addition, a textile machine can have a plurality of workstations arranged adjacent to one another. The workstations can be, for example, spinning points or the like. It is also possible to design the workstations as winding points, at which a thread is wound onto a bobbin, for example a cross-wound bobbin. For example, a thread is produced on a spinning machine from a presented fiber composite that, after leaving a spinning unit-viewed in the direction of the thread path-passes sequentially through a take-off apparatus and a thread accumulator and is finally wound up on the thread winding apparatus, i.e., the winding point.

An identifier in a network is used to define unique identities for devices such as, for example, textile machines, applications, or services. An example of an identifier is, for example, the IP address that is used to identify a specific textile machine as a device in the network. Other examples of identifiers are MAC addresses or a host name. The technical features of an identifier can comprise its length, format, validity period, and uniqueness. For example, an IPv4 address consists of four blocks of numbers, while an IPv6 address consists of eight blocks of numbers and letters. A MAC address consists of six blocks of numbers and letters, while a host name consists of a character string of letters, numbers, and hyphens. The uniqueness of an identifier is an important feature in order to ensure that each textile machine, each application or each service in the network can be uniquely identified.

According to a further advantage, it can be provided that initiating comprises the following step:
transmitting a request to the one or more textile machines within the network, wherein the request is designed as a unicast and/or a multicast and/or a broadcast request.

In addition, it is conceivable within the scope of the invention that the request comprises an IP address and/or a MAC address.

This makes it possible that it can be ensured that all textile machines in the network are detected significantly more effectively and efficiently. Furthermore, sending a request to all textile machines has the advantage of receiving the information necessary for configuration, such as the MAC address of the textile machine, upon request on the basis on the transmitted request.

A broadcast request in a network is a method of sending information or requests to all machines in a network. An example of such a request would be the search for a specific device or service in the network. The technical features of a broadcast request can be the employed protocol layer, the IP address, or the port number management of a broadcast request.

Other types of requests can also optionally be transmitted, for example a unicast request and/or a multicast request. The unicast request is only directed to one recipient; the multicast request can be directed to a plurality of or a group of recipients.

It can be provided within the scope of the invention that identifying comprises the following step:
receiving a response from the one or more textile machines from the network, wherein the response has the respective identifier of the textile machine, the respective identifier being used for providing and transmitting the network configuration to the one or more textile machines in the network.

A further advantage within the scope of the invention can be achieved if the respective identifier of the one or more textile machines has a MAC address.

This has the advantage that, using the obtained identifier, it can be ensured more quickly and very easily that the network configuration can be provided and transmitted more efficiently to the one or more textile machines. The received identifier, preferably the received MAC address, makes it possible for the configuration unit to obtain a unique address of one or more textile machines in the network for effective and fast transmission of the respective network configuration.

Furthermore, it is conceivable within the scope of the invention that the method comprises the further subsequent step which is executed by the configuration unit:
receiving a confirmation message from the one or more textile machines in the network that the transmitted network configuration is set on the one or more textile machines.

This makes it possible for the configuration unit, in a very simple and fast manner, to receive information about the successful completion of the configuration of the respective textile machine in order to save the corresponding status and advantageously offer further services to the now configured textile machine.

In addition, within the scope of the invention, it can be advantageous that the data are transmitted between the configuration unit and the one or more textile machines by means of a network protocol, in particular by means of a User Datagram Protocol, preferably by means of an Auto-Discovery Protocol.

This has the advantage that, during data transmission for a network configuration to one or more textile machines, a collision with other devices or machines within the network can advantageously be prevented. Furthermore, this makes it possible to ensure efficient, secure and reliable data transmission between the configuration unit and the one or more textile machines.

A network protocol is a definition of rules and procedures that allow communication between the network components or the devices in a network. A network protocol defines how data are exchanged between the devices and how these data are processed. It also regulates the structure of data packets, the addressing and routing of data packets, as well as error detection and correction. Examples of network protocols are the Internet Protocol (IP), the Transmission Control Protocol (TCP), and the User Datagram Protocol (UDP). Technical features of a network protocol can comprise, among other things, the format of data packets, the size of data packets, the type of transmission, i.e. connection-oriented or connectionless, or checking data packets for errors.

It can be provided within the scope of the invention that the data transmission is provided in the form of a datagram, wherein the datagram has at least one header portion. According to a further advantage, it can be provided that the datagram comprises the header portion and a data portion, wherein the datagram has a total length which is dimensioned such that secure and complete data transmission within a frame or a data transmission frame is ensured, and advantageously no data packets can be lost. The header portion preferably has a total length of at least 15 bytes up to and including 30 bytes, more preferably of at least 18 bytes up to and including 22 bytes. This ensures that the relevant information is included. If, according to the preferred embodiment, a data portion is provided in addition to the header portion, the data portion preferably has a total length of at least 1 byte up to a maximum of 255 bytes. According to a preferred embodiment, the datagram can thus have a total length of at least 15 bytes up to and including 285 bytes, more preferably of at least 18 bytes up to and including 277 bytes, and absolutely preferably of at least 20 bytes when only one header portion is provided, up to and including 275 bytes when a header portion and a data portion are provided.

A frame is a number of data that are transmitted as a unit. It contains addresses and the necessary control information of a network protocol. A frame is usually transmitted serially bit by bit and contains a header field and a trailer field. The trailer field is the data set that ends the frame. Trailer fields are data fields which can comprise data for error detection and correction, checksum fields, and flags as identification fields. They “frame” the data.

A datagram is a unit of data transmitted as a single packet via a network. It typically contains a data portion or payload, which contains the actual data, as well as a header portion, which may contain information about the source and destination of the data, the size of the packet, the checksum, and other specific information. Datagrams are typically used in connectionless network protocols such as the User Datagram Protocol (UDP) which do not require a prior connection to be established between the involved devices. This makes datagrams easier and faster to transmit than other types of data packets that are used for connection-oriented transmission, such as the Transmission Control Protocol (TCP). Technical features of a datagram can be, for example, the maximum size of the packet, the length of the headers and footers, checking the data integrity by a checksum, as well as addressing and routing information.

It is also possible for the network to be designed as a local network, preferably a data network and/or an Ethernet and/or a LAN (local area network) or a WLAN (wireless local area network). Furthermore, the communication network can be designed as a fixed network, preferably as an Internet, or a radio network, preferably Bluetooth or a WLAN network, or a mobile network, in particular according to the 2G/3G/4G/5G/6G standard, and/or as a campus network. The network and the communication network are correspondingly different networks for data transmission. In particular, the network and the communication network are based on different network technologies.

Furthermore, it can be provided within the scope of the invention that the network comprises at least two subnetworks, in particular subnets. The network and each subnetwork can each comprise a network interface with the communication network, wherein the network interface is adapted such that data are transmitted between the configuration unit and the one or more textile machines via the respective network interface of the network and/or the subnetwork. This has the advantage that direct and more effective data transmission can take place in a hierarchical network structure. Furthermore, this allows the transmission of requests to the textile machines to be advantageously ensured in the subnetworks or subnets. Furthermore, by dividing the network into subnetworks or subnets, this allows more efficient management and control of data transmission to be ensured and can improve the performance and security of the entire network. The respective network interface can be designed, for example, as a radio interface and/or as a Bluetooth interface or as a mobile radio interface or as a network router.

A subnetwork or subnet is to be understood in particular as a section of the network which can consist of one or more textile machines which are connected, for example, in the same geographical or local location on an industrial site. The subnet is separated from other networks by a subnet mask and receives its own network address. This makes it possible to manage and control the data traffic within the subnet more efficiently.

Technical features of a subnet can comprise the number of devices in the subnet, the size of the subnet, the subnet mask, the routing information, the protocols, and the bandwidth. Subnets are an important component of networks, especially in large corporate networks.

An object of the invention is also a system for automated transmission of a network configuration, comprising a configuration unit and one or more textile machines in a network, wherein data are transmitted between a configuration unit and the one or more textile machines via a communication network with the network, the system being adapted to execute the method according to the invention.

It is also advantageous if the network comprises at least two subnetworks, in particular subnets, wherein the network and each subnetwork each have a network interface with the communication network, the network interface being adapted such that data are transmitted between the configuration unit and the one or more textile machines via the respective network interface of the network and/or the subnetwork.

Thus, the system according to the invention brings the same advantages as have been described in detail with reference to a method according to the invention.

An object of the invention is also an apparatus for data processing, comprising means for executing the steps of the method according to the invention. Thus, the apparatus according to the invention brings the same advantages as have been described in detail with reference to a method according to the invention.

An object of the invention is also a computer program, in particular a computer program product, comprising instructions that, when the computer program is executed by a computer, cause the computer to execute the method according to the invention. Thus, the computer program according to the invention brings the same advantages as have been described in detail with reference to a method according to the invention.

As the computer, an apparatus for data processing can be provided, for example the apparatus according to the invention which executes the computer program. The computer can have at least one processor for executing the computer program. A non-volatile data memory can also be provided, in which the computer program can be stored and from which the computer program can be read by the processor for execution. Further, the computer program can also be directly integrated into a machine software of the machine.

It is also conceivable that the computer comprises at least one integrated circuit, such as a microprocessor or an application specific-integrated circuit (ASIC) or an application-specific standard product (ASSP) or a digital signal processor (DSP) or a field-programmable gate array (FPGA) or the like. The computer can further have at least one interface for data exchange, such as an Ethernet interface or an interface for LAN (local area network) or WLAN (wireless local area network) or system-on-a-chip (SoC) or other radio interface such as Bluetooth or near-field communication (NFC). Further, the computer can be implemented as one or more control devices, i.e., also as a system of control devices. For example, the computer can also be provided in a cloud and/or as a server, in order to provide data processing for a local application via the interface. It is also possible that the computer is implemented as a mobile device, such as a smartphone.

An object of the invention can also be a computer-readable storage medium which comprises the computer program according to the invention. The storage medium is designed, for example, as a data storage, such as a hard disk and/or a non-volatile memory and/or a memory card. The storage medium can, for example, be integrated into the computer.

An object of the invention is also a textile machine comprising a network interface with a communication network, wherein data are transmitted between the textile machine and a configuration unit via the network interface with the communication network, the network interface being adapted to execute the method according to the invention. Thus, the textile machine according to the invention brings the same advantages as have been described in detail with reference to a method according to the invention.

In addition, the method according to the invention can also be executed as a computer-implemented method.

Further advantages, features and details of the invention will be apparent from the following description, in which exemplary embodiments of the invention are described in detail with reference to the drawings. The features mentioned in the claims and in the description can be substantial to the invention individually or in any combination. The following are shown:

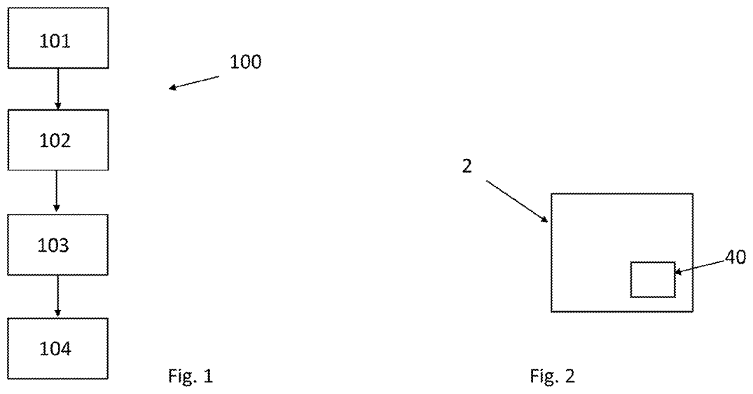

FIG. 1 schematically shows an exemplary embodiment of the method according to the invention,

FIG. 2 schematically shows an exemplary embodiment of an apparatus according to the invention along with a computer program according to the invention, and

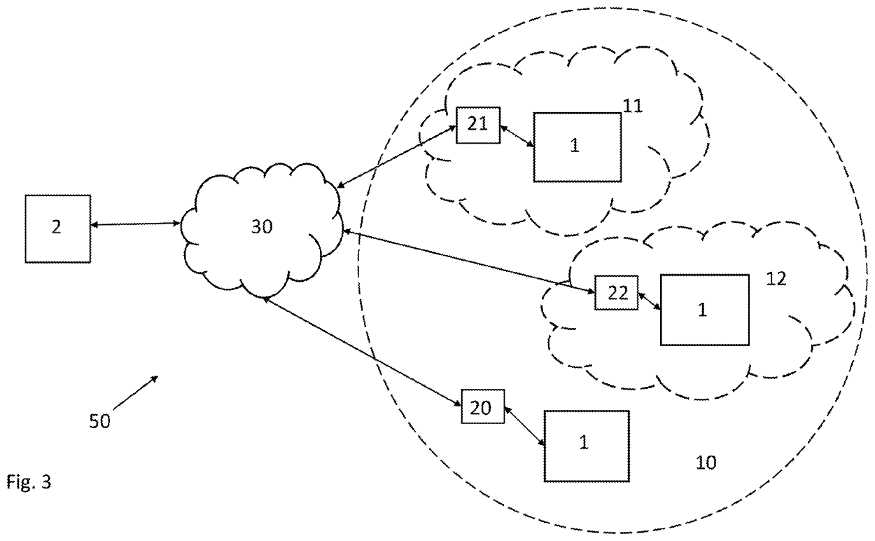

FIG. 3 schematically shows an exemplary embodiment of a system according to the invention.

In the following figures, the identical reference signs are used for the same technical features even of different exemplary embodiments.

It is a core idea of the invention that the initiation of the assignment of a network configuration is initiated not by a textile machine 1, but from a central location, i.e., for example, by the control system which comprises a configuration unit 2. For the automatic transmission of the network configuration, the configuration unit scans the network 10, i.e. it starts detection of textile machines within the network 10 by transmitting or sending a request such as a broadcast request, for example. In response to the transmitted request, the configuration unit 2 receives one or more responses or response messages from one or more textile machines 1. As a result, the control system receives an identifier with a response from a textile machine 1, which identifier has, for example, the MAC address of the textile machine 1. The identifier supports the unit 2 on the one hand with identifying textile machines within the network on the basis of the obtained MAC address, and on the other hand, the transmission of the network configuration to the textile machine is carried out on the basis of the respective received MAC address. After the network configuration has been carried out, a textile machine or a plurality of textile machines can use the various services of the system 50.

During data transmission between the control system or the configuration unit 2 and one or more textile machines 1, a transmission protocol or a network protocol is used which prevents collisions during data transmission with other devices or machines within the network. The protocol is based on a connectionless UDP/IP protocol.

FIG. 1 is an exemplary embodiment of a method 100 according to the invention. FIG. 1 illustrates, according to exemplary embodiments of the invention, a method 100 for automated transmission of a network configuration for one or more textile machines 1 in a network 10. Data are transmitted between a configuration unit 2 and the one or more textile machines 1 via a communication network 30 to the network 10. The method 100 comprises the following steps which are executed by the configuration unit 2.

According to step 101, the configuration unit 2 initiates detection of one or more textile machines 1 within the network 10 via the communication network 30 for transmitting the network configuration.

Then, in step 102, the one or more textile machines 1 within the network 10 are identified on the basis of a respective identifier of the one or more textile machines 1 obtained by the initiated detection 101.

In step 103, the network configuration for each detected 101 and identified 102 textile machine 1 in the network 10 is provided by the configuration unit 2.

According to step 104, each provided 103 network configuration is transmitted from the configuration unit 2 to the one or more identified 102 textile machines 1 in the network 10 on the basis of the respective identifier.

Finally, in a further step of the method according to the invention, the configuration unit 2 can receive a confirmation message from the one or more textile machines 1 in the network 10 that the transmitted 104 network configuration is set on the one or more textile machines 1.

FIG. 2 shows a computer program 40 which comprises commands that, when the program is executed by a computer 2, cause the computer to execute the steps of the method 100 according to exemplary embodiments of the invention. An apparatus 2 for data processing is also shown, wherein this data processing apparatus 2 can comprise means for executing the steps of a method 100 according to exemplary embodiments of the invention.

FIG. 3 shows an exemplary embodiment of a system 50 according to the invention. FIG. 3 shows an exemplary system 50 which comprises a configuration unit 2 and a plurality of textile machines 1 in a network 10. In addition, two subnetworks 11, 12 or subnets 11, 12 of the network 10 are shown in FIG. 3.

Furthermore, FIG. 3 shows a communication network 30 via which data can be transmitted between the configuration unit 2, which can be associated, for example, with a control system, and the one or more textile machines 1.

The network 10 shown in FIG. 3 and each subnetwork 11, 12 each have a network interface 20, 21, 22 with the communication network 30. The network interface 20, 21, 22 is adapted such that data can be transmitted between the configuration unit 2 and the one or more textile machines 1 via the respective network interface 20, 21, 22 of the network 10 and/or the subnetwork 11, 12.

The process for assigning or transmitting a network configuration, comprising a necessary IP address, takes place automatically and recurrently in the system 50 shown in FIG. 3, initiated by the configuration unit 2 of the control system or central master computer.

First, the configuration unit 2 initiates detection and identification of one or more textile machines 1 within the network 10 and the two subnetworks 11, 12. A broadcast request is sent from the configuration unit via the communication network 30 to the one or more textile machines 1, wherein the request has a broadcast IP address and/or a broadcast MAC address. The request is transmitted to the respective textile machine 1 via the respective network interface 20, 21, 22.

The unit 2 then receives one or more responses from the one or more textile machines 1 via the respective network interface 20, 21, 22 and via the communication network 30, wherein the response comprises the IP address of the configuration unit 2 and the respective MAC address of the textile machine.

The configuration unit 2 then transmits a message via the communication network 30 to the one or more textile machines 1, wherein the message has the network configuration for the respective textile machine 1, and the message comprises a broadcast IP address and the respective MAC address of the textile machine 1.

The respective textile machine 1 sets the specified network configuration and confirms this with a corresponding confirmation message, wherein this message has the IP address of the configuration unit 2 and the MAC address of the textile machine 1.

The configuration unit 2 then transmits a message to all textile machines 1 within the network 10 and the two subnetworks 11, 12, wherein the message has information about the available services.

The network interfaces 21, 22 of the two subnetworks 11, 12 can be configured such that data transmission between the configuration unit 2 and the subnetworks 11, 12 is ensured and can be adapted such that one or more textile machines 1 in the respective subnetwork 11, 12 can be detected and identified, and the data traffic within the subnetwork 11, 12 can be controlled. The subnet mask of the respective subnetwork 11, 12 defines the range of the IP address that should be assigned to the subnet.

The foregoing explanation of embodiments describes the present invention by way of example only. Of course, individual features of the embodiments can be freely combined with each other, if technically useful, without departing from the scope of the present invention.

### LIST OF REFERENCE SIGNS

1 Textile machine
2 Configuration unit
10 Network
11, 12 Subnetwork
20, 21, 22 Network interface
30 Communication network
40 Computer program
50 System
100 Method
101 First method step, initiating
102 Second method step, identifying
103 Third method step, providing
104 Fourth method step, transmitting

1. A method (100) for automated transmission of a network configuration for one or more textile machines (1) in a network (10), wherein data are transmitted between a configuration unit (2) and the one or more textile machines (1) via a communication network (30) to the network (10), the method (100) comprising the following steps which are executed by the configuration unit (2):
initiating (101) detection of the one or more textile machines (1) within the network (10) via the communication network (30) for transmitting the network configuration,
identifying (102) the one or more textile machines (1) within the network (10) on the basis of a respective identifier of the one or more textile machines (1) obtained by the initiated detection (101),
providing (103) the network configuration for each detected (101) and identified (102) textile machine (1) in the network (10),
transmitting (104) each provided network configuration to the one or more identified textile machines (1) in the network (10) on the basis of the respective identifier.

2. The method (100) according to claim 1, characterized in that initiating (101) comprises the following step:
transmitting a request to the one or more textile machines (1) within the network (10), wherein the request is implemented as a unicast and/or a multicast and/or a broadcast request.

3. The method (100) according to claim 2, characterized in that the request comprises an IP address and/or a MAC address.

4. The method (100) according to claim 1, characterized in that that identifying (102) comprises the following step:
receiving a response from the one or more textile machines (1) from the network (10), wherein the response has the respective identifier of the textile machine (1), the respective identifier being used for providing (103) and transmitting (104) the network configuration to the one or more textile machines (1) in the network (10).

5. The method (100) according to claim 4, characterized in that the respective identifier of the one or more textile machines (1) has a MAC address.

6. The method (100) according to claim 1, characterized in that the method (100) comprises the further subsequent step which is executed by the configuration unit (2):
receiving a confirmation message from the one or more textile machines (1) in the network (10) that the transmitted (104) network configuration is set on the one or more textile machines (1).

7. The method (100) according to claim 1, characterized in that the data transmission between the configuration unit (2) and the one or more textile machines (1) takes place by means of a network protocol, in particular by means of a User Datagram Protocol (UDP), preferably by means of an Auto-Discovery Protocol.

8. The method (100) according to claim 1, characterized in that the data transmission is provided in the form of a datagram, wherein the datagram has at least one header portion.

9. The method (100) according to claim 8, characterized in that the datagram comprises the header portion and a data portion, wherein the datagram has a total length which is dimensioned such that secure and complete data transmission within a frame or a data transmission frame is ensured.

10. The method (100) according to claim 1, characterized in that the network (10) comprises at least two subnetworks (11, 12), in particular subnets (11, 12),
wherein the network (10) and each subnetwork (11, 12) each comprise a network interface (20, 21, 22) to the communication network (30),
wherein the network interface (20, 21, 22) is adapted to ensure that data are transmitted between the configuration unit (2) and the one or more textile machines (1) via the respective network interface (20, 21, 22) of the network (10) and/or the subnetwork (10, 11),
wherein the network (10) is designed as a local network, preferably LAN or WLAN or Ethernet, and/or the communication network (30) is designed as a radio network, preferably Bluetooth or a WLAN network.

11. A system (50) for automated transmission of a network configuration, comprising a configuration unit (2) and one or more textile machines (1) in a network (10), wherein data are transmitted between a configuration unit (2) and the one or more textile machines (1) via a communication network (30) to the network (10),
the system (50) being adapted to execute the method (100) according to claim 1.

12. The system (50) according to claim 11, characterized in that the network (10) comprises at least two subnetworks (11, 12), in particular subnets (11, 12), wherein the network (10) and each subnetwork (11, 12) each have a network interface (20, 21, 22) with the communication network (30),
the network interface (20, 21, 22) being adapted such that data are transmitted between the configuration unit (2) and the one or more textile machines (1) via the respective network interface (20, 21, 22) of the network (10) and/or the subnetwork (10, 11).

13. An apparatus (2) for data processing, comprising means for executing the steps of the method (100) according to claim 1.

14. A computer program (40) comprising commands that, when the computer program (40) is executed by a computer (2), cause the computer to execute the steps of the method (100) according to claim 1.

15. A textile machine (1) comprising a network interface (20, 21, 22) to a communication network (30), wherein data are transmitted between the textile machine (1) and a configuration unit (2) via the network interface (20, 21, 22) to the communication network (30), the network interface (20, 21, 22) being adapted to execute the method according to claim 1.
